(19) United States
(12) Patent Application Publication
(10) Pub. No.: US 2015/0125564 A1
(43) Pub. Date: May 7, 2015

(54) Dumpling maker

(71) Applicant: Chi Chiao Frozen Foods Co., Ltd., Changhua (TW)

(72) Inventor: Ying-Sheng Chen, Changhua (TW)

(73) Assignee: Chi Chiao Frozen Foods Co., Ltd., Changhua (TW)

(21) Appl. No.: 14/073,886

(22) Filed: Nov. 7, 2013

(51) Int. Cl. A21C 5/00

(52) U.S. Cl. CPC A21C 5/003
USPC 425/297

(57) ABSTRACT

A dumpling maker is provided with a dough container; two rotating rollers for compressing dough batch into a continuous dough sheet; dough pressing units for further pressing the continuous dough sheet; hand wheels each for adjusting a gap between the gauging rollers; a flour hopper for applying an amount of flour onto the continuous dough sheet; a brush member for rubbing the continuous dough sheet; a dough cutting unit for cutting the continuous dough sheet into respective dough sheets; a stuffing hopper; a mixer for uniformly mixing stuffing contained in the stuffing hopper; a stuffing feeding device for feeding an amount of the stuffing from the stuffing hopper onto each respective dough sheet; a dough mold for shaping the respective dough sheets into groove-shaped dough sheets; and two pressing rollers for pressing curved, upward bent portions of the groove-shaped dough sheets together to form dumplings.

### BACKGROUND OF THE INVENTION

1. Field of the Invention

The invention relates to dumpling making machines and more particularly to a dumpling maker.

2. Description of Related Art

A conventional dumpling making machine comprising a dough sheet holder for holding dough sheets; a transmission mechanism for transmitting the dough sheets; a flour container for containing flour to be applied over the dough sheets; a stuffing hopper for storing stuffing; a stuffing control device for controlling the amount of the stuffing to be fed onto a sheet; a stuffing feeding device for feeding the stuffing onto a dough sheet; a hitting device for hitting a central part of the dough sheet to form a dent for receiving the stuffing; two rotating wheels; a plurality of dumpling forming devices disposed on peripheral surfaces of the rotating wheels for folding up the dough sheet to form a dumpling; a pushing rod for pushing the finished dumplings out of the forming device; a movable brush member for cleaning the dumpling forming device; and a dumpling collector and a dough sheet collector for collecting the finished dumplings and remaining dough sheets respectively.

Notwithstanding the conventional dumpling making machine, the invention is neither taught nor rendered obvious thereby.

### SUMMARY OF THE INVENTION

It is therefore one object of the invention to provide a dumpling maker comprising a dough container for storing a batch of dough; two opposite rotating rollers disposed downstream of the dough container to initially compress the batch of dough being conveyed into a continuous dough sheet; a plurality of dough pressing units disposed downstream of the rotating rollers, each of the dough pressing units having two opposite gauging rollers for further pressing the continuous dough sheet; a plurality of hand wheels each for adjusting a gap between the gauging rollers of each of the dough pressing units; a first conveyor for moving the continuous dough sheet forward; a flour hopper disposed downstream of the dough pressing units for applying a predetermined amount of flour onto the continuous dough sheet; a brush member disposed downstream of the flour hopper for rubbing the continuous dough sheet; a dough cutting unit disposed downstream of the brush member for cutting the continuous dough sheet into a plurality of respective dough sheets wherein remnants of the continuous dough sheet are conveyed to the dough container; a second conveyor for moving the respective dough sheets forward; a stuffing hopper disposed above the second conveyor; a mixer disposed above the stuffing hopper for uniformly mixing stuffing contained in the stuffing hopper; a stuffing feeding device disposed under the stuffing hopper for feeding a predetermined amount of the stuffing from the stuffing hopper onto each of the respective dough sheets conveyed by the second conveyor; a dough mold disposed downstream of the stuffing feeding device for shaping the respective dough sheets having the stuffing rested thereon into groove-shaped dough sheets by bending; and at least one pressing roller disposed downstream of the dough mold for pressing curved, upward bent portions of the groove-shaped dough sheets together to form a plurality of elongated dumplings having both ends open.

The above and other objects, features and advantages of the invention will become apparent from the following detailed description taken with the accompanying drawings.

### BRIEF DESCRIPTION OF THE DRAWINGS

FIG. 1 is a perspective view of a dumpling maker according to the invention;

FIG. 2 is an end view of FIG. 1;

FIG. 3 is an enlarged view of the left portion of FIG. 2 showing a dough sheet being produced;

FIG. 4 is an enlarged view of the upper portion of FIG. 2 showing a dough sheet being produced;

FIG. 5 is an enlarged view of the right portion of FIG. 2 showing a dough sheet being produced;

FIG. 6 is an enlarged view of the intermediate portion of FIG. 1 showing a dough sheet being produced; and

FIG. 7 is an enlarged view of the right portion of FIG. 1 showing dumplings being produced.

### DETAILED DESCRIPTION OF THE INVENTION

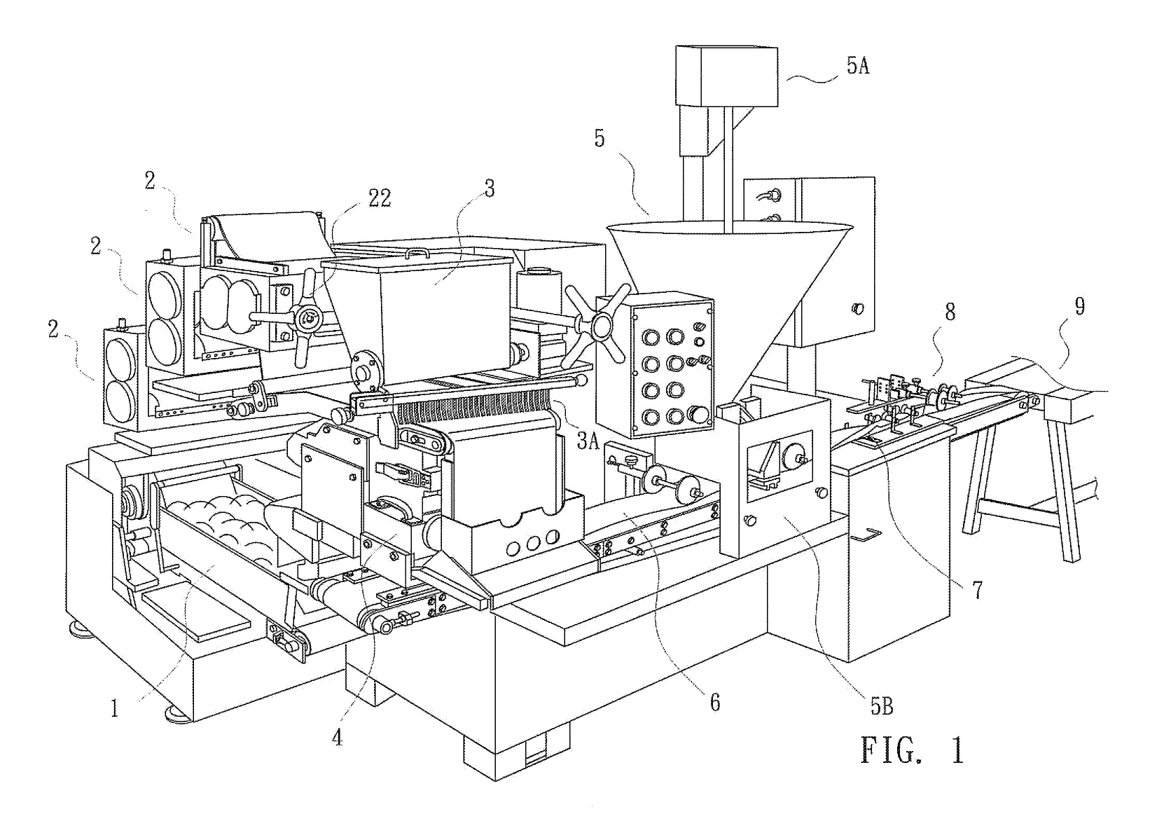

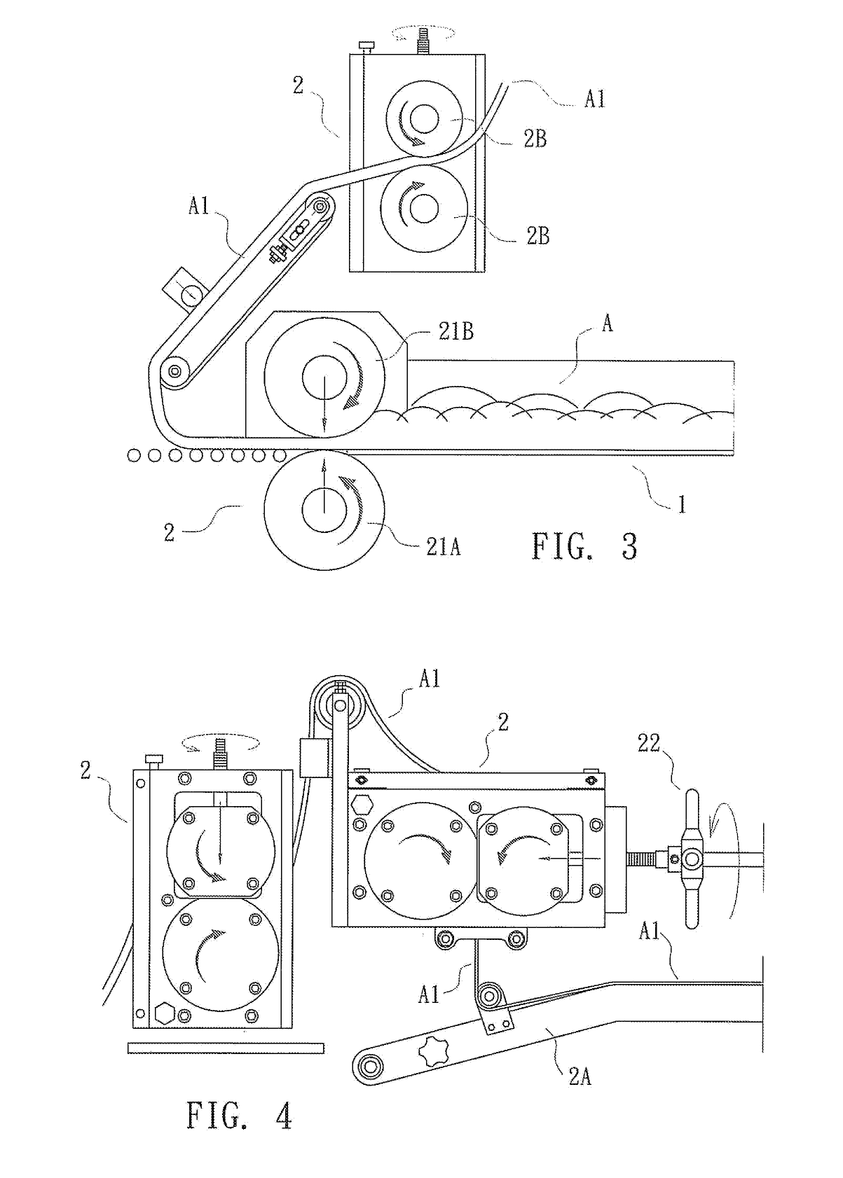

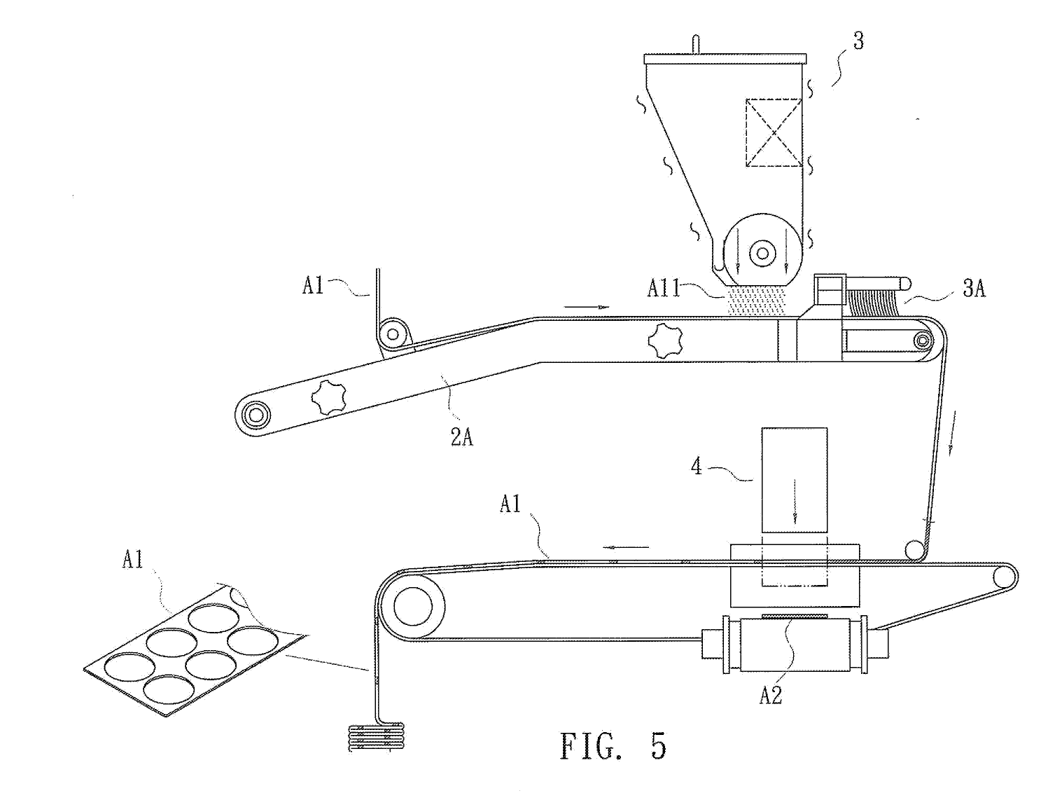

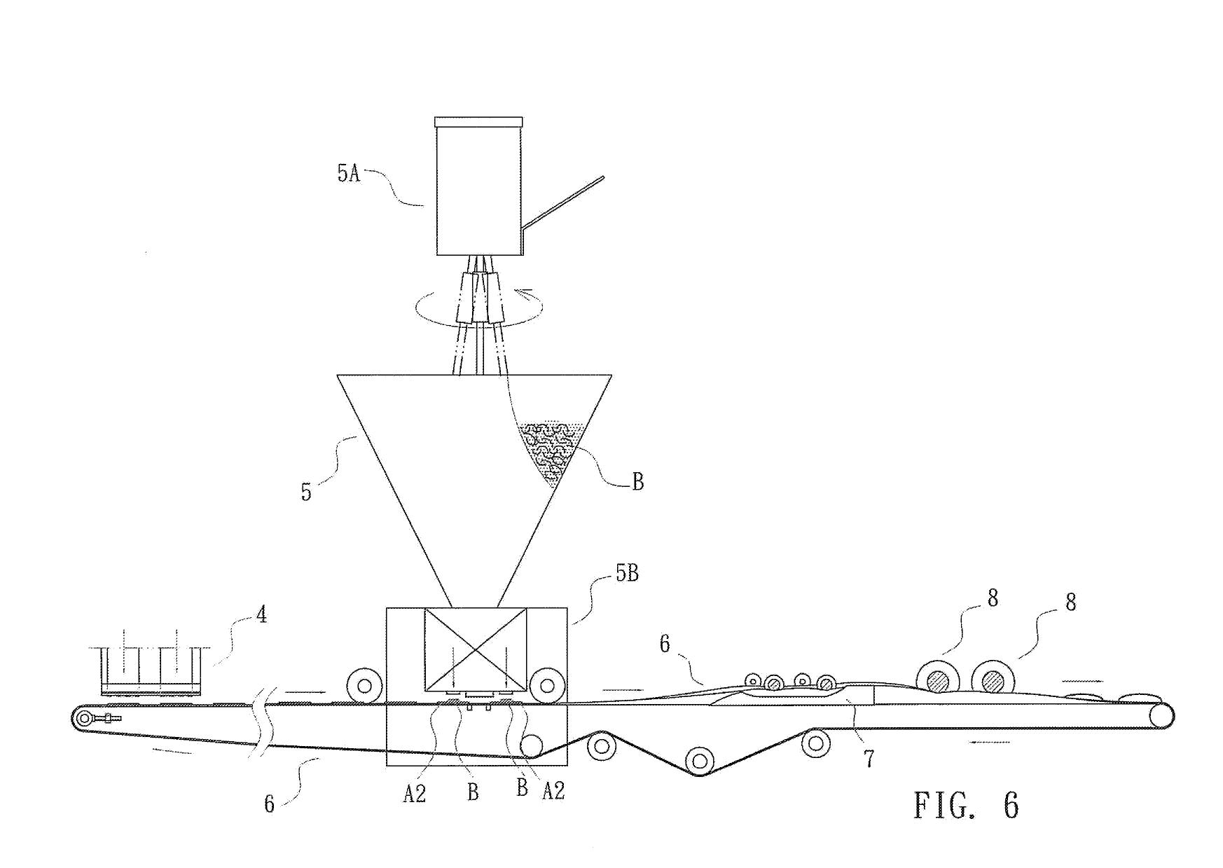

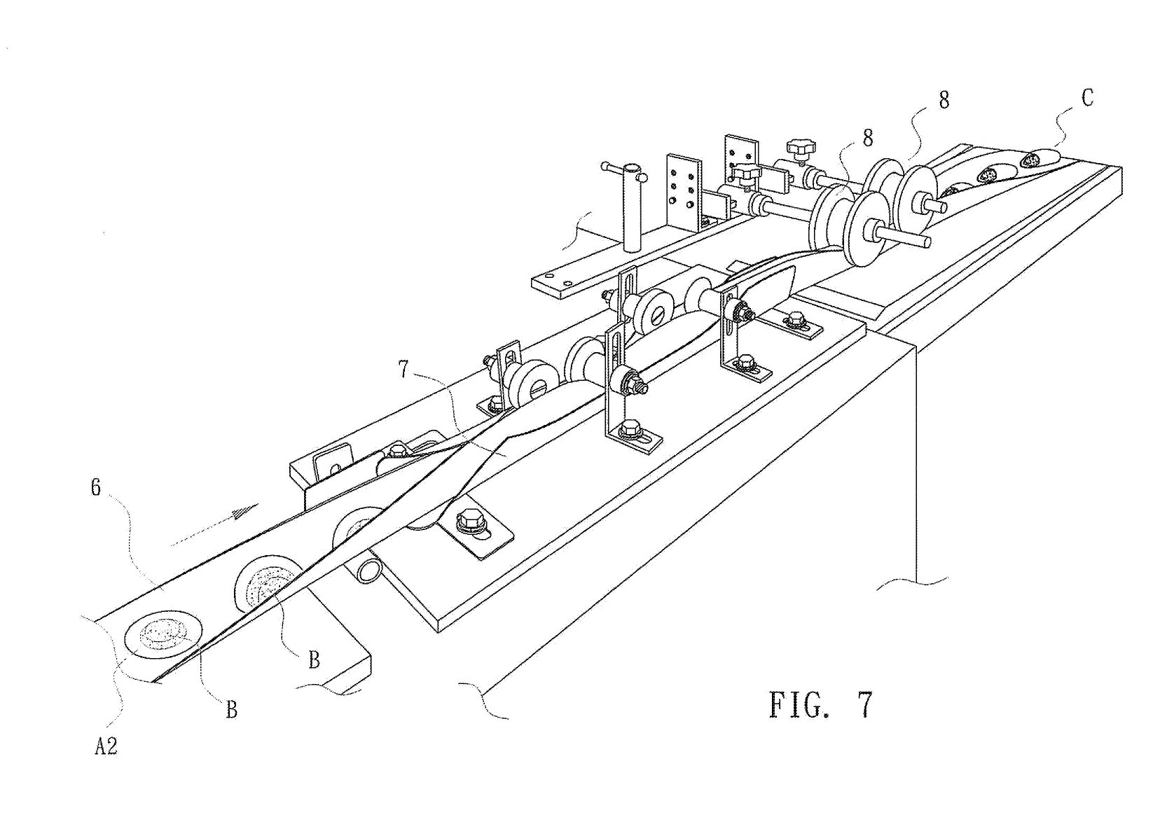

Referring to FIGS. 1 to 7, a dumpling maker in accordance with the invention comprises the following components as discussed in detail below.

A lower dough container 1 for storing a batch of dough A is provided. Two opposite rotating rollers 21A, 21B are provided downstream of the dough container 1 to initially compress the batch of dough being conveyed into a continuous dough sheet A1. A series of dough pressing units 2 are provided downstream of the rotating rollers 21A, 21B. Each of the dough pressing units 2 have two opposite gauging rollers 2B for further pressing the dough sheet A1 so that a smooth, consistent dough sheet A1 having a predetermined even thickness is obtained. A hand wheel 22 is provided for adjusting a gap between the gauging rollers 2B of the most downstream dough pressing unit 2 so as to adjust the dough thickness. It is noted that one hand wheel 22 is shown for the sake of brevity only.

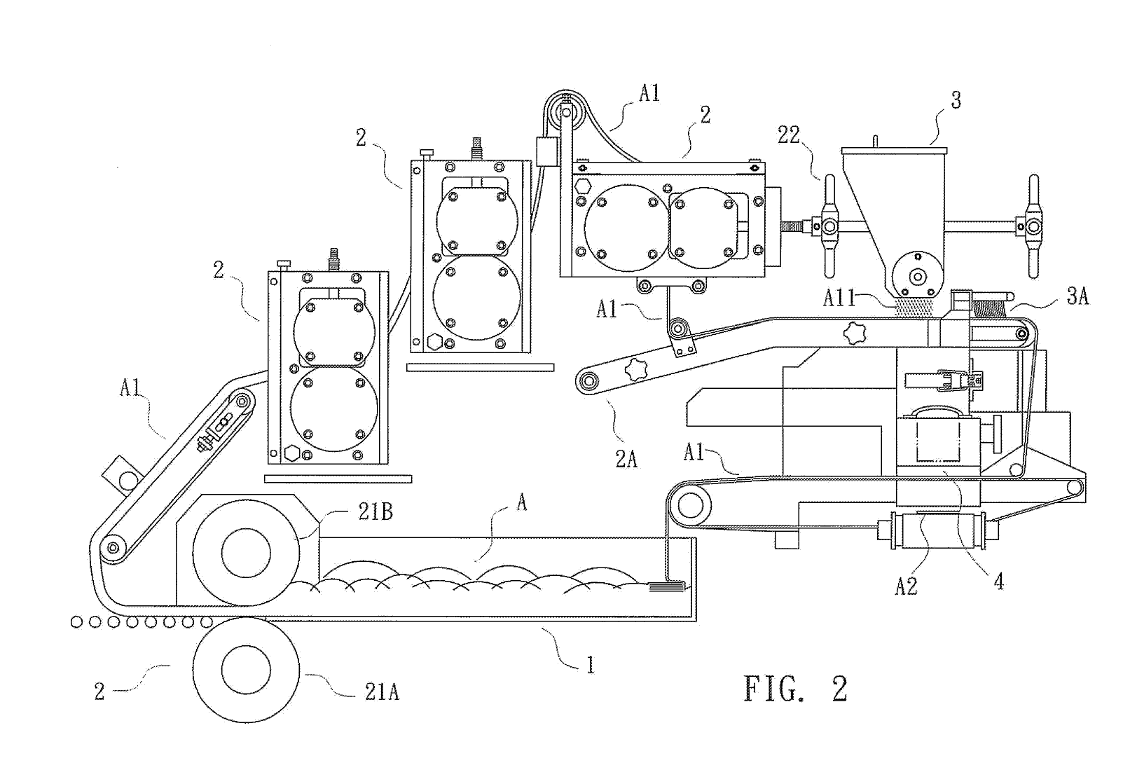

A first conveyor 2A is provided downstream of the rightmost dough pressing unit 2 (see FIG. 2). The second conveyor 2A can move the dough sheet A1 to a position under a flour hopper 3 for storing flour All. The flour hopper 3 can be controlled to apply a desired amount of flour All onto the dough sheet A1 for the purpose of keeping a top surface of the dough sheet A1 dry. A brush member 3A is provided downstream of the flour hopper 3 for rubbing the dough sheet A1 so that the flour All can be uniformly applied on the dough sheet A1. A dough cutting unit 4 is provided downstream of the brush member 3A for cutting the dough sheet A1 into a plurality of respective dough sheets A2 of circular shape. The remnants of the dough sheet A1 is conveyed to the dough container 1 to be collected and reused in a next dough making stage.

A stuffing hopper 5 for containing stuffing B is provided above a second conveyor 6. A mixer 5A is provided above the stuffing hopper 5 and has one beater (not numbered) for uniformly mixing the stuffing B. A stuffing feeding device 5B is provided below the stuffing hopper 5. The respective dough sheets A2 are conveyed to the stuffing feeding device 5B by the second conveyor 6. The stuffing feeding device 5B is controlled to feed a predetermined amount of stuffing B from the stuffing hopper 5 onto each of the respective dough sheets A2. A dough mold 7 is provided downstream of the stuffing feeding device 5B for shaping the respective dough sheets A2 having stuffing B rested thereon into groove-shaped ones by bending from both sides. Two pressing rollers 8 are provided downstream of the dough mold 7 and adapted to press the curved, upward bent portions of the respective dough sheets A2 together to form a plurality of elongated dumplings C having both ends open. The dumplings C are moved to a table 9 for collection by the second conveyor 6.

While the invention has been described in terms of preferred embodiments, those skilled in the art will recognize that the invention can be practiced with modifications within the spirit and scope of the appended claims.

What is claimed is:

1. A dumpling maker comprising:
a dough container for storing a batch of dough;
two opposite rotating rollers disposed downstream of the dough container for compressing the batch of dough into a continuous dough sheet;
a plurality of dough pressing units disposed downstream of the rotating rollers, each of the dough pressing units having two opposite gauging rollers for further pressing the continuous dough sheet;
a plurality of hand wheels each for adjusting a gap between the gauging rollers of each of the dough pressing units;
a first conveyor for moving the continuous dough sheet forward;
a flour hopper disposed downstream of the dough pressing units for applying a predetermined amount of flour onto the continuous dough sheet;
a brush member disposed downstream of the flour hopper for rubbing the continuous dough sheet;
a dough cutting unit disposed downstream of the brush member for cutting the continuous dough sheet into a plurality of respective dough sheets wherein remnants of the continuous dough sheet are conveyed to the dough container;
a second conveyor for moving the respective dough sheets forward;
a stuffing hopper disposed above the second conveyor;
a mixer disposed above the stuffing hopper for uniformly mixing stuffing contained in the stuffing hopper;
a stuffing feeding device disposed under the stuffing hopper for feeding a predetermined amount of the stuffing from the stuffing hopper onto each of the respective dough sheets conveyed by the second conveyor;
a dough mold disposed downstream of the stuffing feeding device for shaping the respective dough sheets having the stuffing rested thereon into a plurality of groove-shaped dough sheets by bending; and
at least one pressing roller disposed downstream of the dough mold for pressing curved, upward bent portions of each of the groove-shaped dough sheets together to form a plurality of elongated dumplings having both ends open.
